(19) United States
(12) Patent Application Publication
(10) Pub. No.: US 2011/0161671 A1
(43) Pub. Date: Jun. 30, 2011

(54) SYSTEM AND METHOD FOR SECURING DATA

(75) Inventor: Harry T. WHITEHOUSE, Portola Valley, CA (US)

(73) Assignee: PSI Systems, Inc., Palo Alto, CA (US)

(21) Appl. No.: 12/976,289

(22) Filed: Dec. 22, 2010

Related U.S. Application Data
(60) Provisional application No. 61/291,651, filed on Dec. 31, 2009.

(51) Int. Cl. H04L 9/08; H04L 9/00

(52) U.S. Cl. 713/171; 713/150

(57) ABSTRACT

A system and method are provided for securing data. The method includes generating a first public encryption key by a cryptographic processor associated with a first computer subsystem; sending the first public encryption key to a second computer subsystem; and receiving first encrypted data at the first computer subsystem, the first encrypted data having been encrypted by the second computer subsystem using the first public encryption key. The method further includes generating a first private encryption key by the cryptographic processor; decrypting the first encrypted data using the first private encryption key generated by the cryptographic processor to obtain a first decrypted data; and storing the first decrypted data in a memory associated with the cryptographic processor.

### CROSS REFERENCE TO RELATED APPLICATION

The present patent application is based on and claims priority to U.S. Provisional Patent Application No. 61/291,651 filed on Dec. 31, 2009, the entire content of which is hereby incorporated by reference.

### BACKGROUND OF THE INVENTION

1. Field of the Invention

The present invention pertains to data security in a computing environment, and in particular to a method and system for securing data.

2. Discussion of Related Art

The Payment Card Industry (PCI) security standards council was founded by American Express, Discover Financial Services, JCB International, MasterCard Worldwide, and Visa, Inc. The objective of the PCI is to enhance payment account data security by driving education and awareness of the PCI security standards. PCI standards are increasingly used by companies that electronically process credit card transactions, and meeting these standards has resulted in manpower and equipment expenditures in the billions of dollars by the companies world wide.

The PCI standards were implemented in response to recurrent security lapses in the 1990's and the current decade by merchants large and small. These security breaches allowed criminals to access very complete credit card data which was then distributed and used by thousands to illegally buy good and services. The losses to merchants and the credit card companies have amounted to billions of dollars.

The current PCI standards still have a glaring security hole in that the credit card data is available in the memory of the merchant's computer during brief time periods, typically during the acquisition of the credit card data from the customer and then again when any credit card authorization transaction is executed. This unencrypted data can easily be obtained by an inside attacker monitoring the memory of the computer or a “robot” or “bot” which has been surreptitiously installed on one or more of the merchant's computers.

FIG. 1 illustrates a conventional system for securing data in which a typical merchant's computer (a server computer) 10 is in communication with a computer of an end customer (customer's computer or client computer) 12 through the internet or world wide web 14. In one embodiment, the customer's computer 12 is loaded with a software application for communicating with the merchant's computer 10. The software application (e.g., a web-browser such as Microsoft's INTERNET EXPLORER, Mozilla's FIREFOX, or Google's CHROME) residing in the customer's computer 12 interacts with a website of the merchant residing at merchant's computer 10 to display a web graphical interface (a webpage) 12A on the customer's computer 12 allowing the customer to input various data relating to the merchandise purchased, personal information such as the customer's desired shipping address, and relevant customer's financial information such as customer's credit card data and address of record associated with the credit card account.

For example, the end customer having all the relevant credit card data can input that data into the webpage 12A when placing an order or subscribing to a recurring service. When the input is completed, the credit card data is encrypted using Secure Socket Layer (SSL) or https:// protocols and transmitted to the merchant's computer (e.g., web server computer) 10. SSL creates a secure connection between the client computer 12 and the server computer 10. SSL uses a cryptographic system that uses two keys to encrypt and decrypt data, a public key known to everyone and employed to encrypt the data and a private or secret key known only to the recipient of the message used to decrypt or decipher the data.

The information in transit is well protected against anyone monitoring the data traffic on the public internet or world wide web, as the SSL protocol is highly secure. Upon receiving the SSL-encrypted data, the server computer 10 decrypts the SSL-encrypted data and places the decrypted data in a memory 10A of the server computer 10. The server computer 10 decrypts the SSL-encrypted data so that, for example, the merchant can see the data, analyze the data and/or check the data for the presence of errors. The server computer 10 may encrypt the data again and may store the encrypted data in a merchant's database 16 in communication with the merchant's computer 10. However, there is a period of time where the data is decrypted. Therefore, during this time period, the decrypted data is available “in the clear” in the memory 10A of the server computer 10. During this time period, an inside attacker or a planted “bot” (a rogue program) running unobtrusively in the server computer 10, could gather and transmit this decrypted credit card data for fraudulent purposes.

In addition, at some point in time, the server computer 10 prepares the credit card data to be sent to an authorizing agent or payment gateway computer 18, such as for example, First Data Merchant Services (FDMS), SUREPAY, AUTHORIZE.NET, etc. In many cases, this will be moments after the credit card data is submitted by the customer and sent by customer's computer 12 or moments after the credit data is received by the server computer 10. The credit card data is assembled in the memory 10A of the server computer 10 decrypted “in the clear” along with the amount of purchase and merchant account ID, typically in an XML format. When the merchant's server computer 10 transmits the credit card data with a payment request to an authorizing agent processor or payment gateway computer 18 (for example via the interne 14 or through a direct communication line 17), an SSL session is instituted between the server computer 10 and the payment gateway computer 18, and the resulting transmitted data is encrypted and is well protected. When the data reaches the payment gateway computer 18, the data is again decrypted in the memory 10A of the server computer 10.

Some merchants will offer to store the customer's credit card data for future use or for a recurring subscription (for example, for automatic payments using the credit card). Frequently, when credit card data is stored for future use, the merchant will encrypt the credit card data with a merchant's encryption key (private key) and will store only the encrypted data in the merchant's database 16. However, when a next financial transaction (e.g., another subsequent purchase made by the customer) is processed, the card data must be read from the database 16. Since the data stored in the database 16 is encrypted, the data is decrypted using a decipher key in the merchant server computer 10 and once again assembled “in the clear” in the memory 10A of the server 10 before being transmitted to the authorizing agent 18. This is another opportunity for a “bot” or insider to sniff out the decrypted or deciphered data and harvest it for criminal use.

The present invention addresses various issues relating to the above and other issues with conventional approaches.

### BRIEF SUMMARY OF THE INVENTION

An aspect of the present invention is to provide a method for securing data. The method includes generating a first public encryption key by a cryptographic processor associated with a first computer subsystem; sending the first public encryption key to a second computer subsystem; and receiving first encrypted data at the first computer subsystem, the first encrypted data having been encrypted by the second computer subsystem using the first public encryption key. The method further includes generating a first private encryption key by the cryptographic processor; decrypting the first encrypted data using the first private encryption key generated by the cryptographic processor to obtain a first decrypted data, wherein the first decrypted data is only seen by the cryptographic processor; and storing the first decrypted data in a memory associated with the cryptographic processor.

Another aspect of the present invention is to provide a computer system for securing data. The computer system includes a cryptographic processor configured to generate a first public encryption key and a first private encryption key; and a first computer subsystem in communication with the cryptographic processor. The computer subsystem is configured to receive first encrypted data having been encrypted using the first public encryption key generated by the cryptographic processor, and transmit the first encrypted data to the cryptographic processor. The cryptographic processor is configured to decrypt the first encrypted data using the first private encryption key to obtain a first decrypted data.

Although the various steps of the method are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 depicts a conventional computer system for securing data in which a typical merchant's computer is in communication with a computer of an end customer through the internet or world wide web;

FIG. 2 depicts a computer system for securing data, according to an embodiment of the present invention;

FIG. 3 depicts a computer system for securing data, according to another embodiment of the present invention; and

FIGS. 4A, 4B and 4C depict a flow chart of the method for securing data, according to an embodiment of the present invention.

### DETAILED DESCRIPTION OF EMBODIMENTS OF THE INVENTION

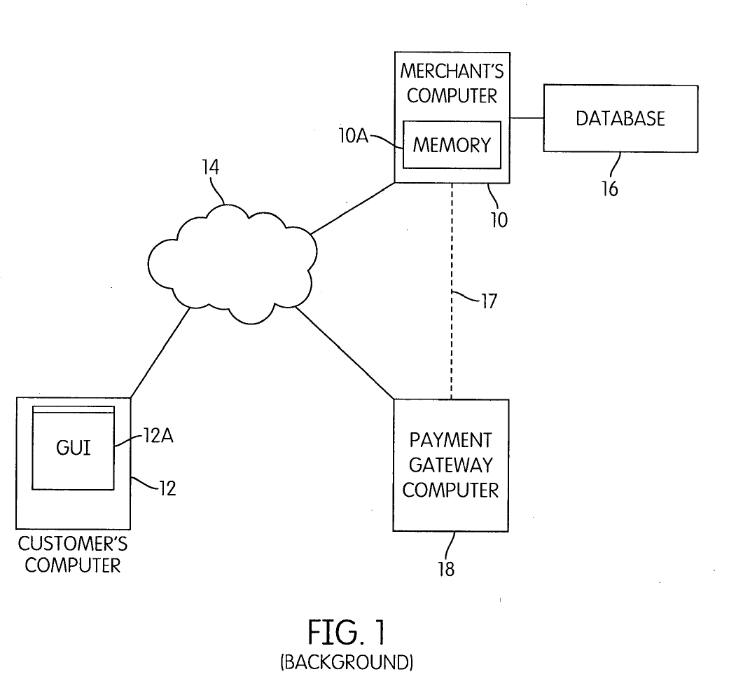

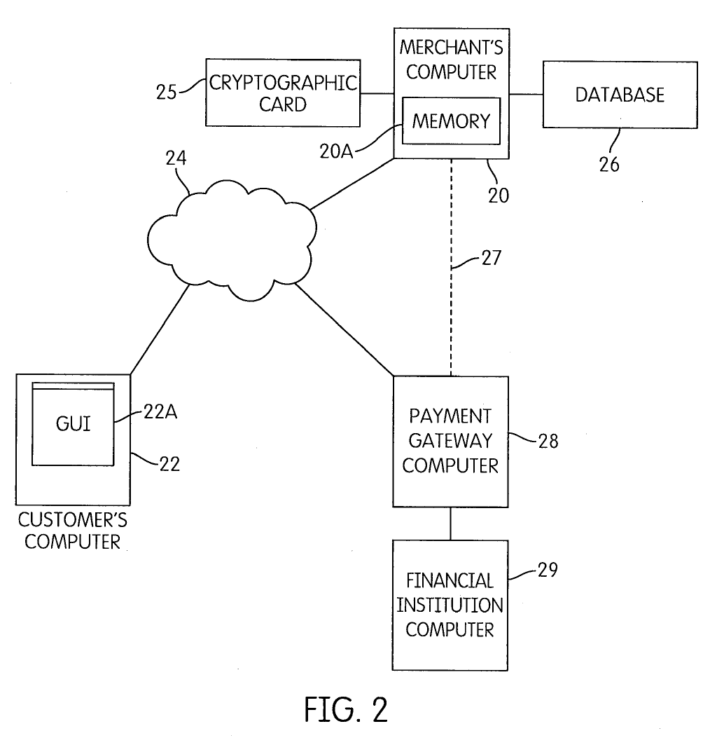

FIG. 2 depicts a computer system for securing data, according to an embodiment of the present invention. Similar to FIG. 1, FIG. 2 illustrates a typical merchant's computer (a server computer) 20 in communication with a computer of an end customer (a client computer) 22 through the internet or world wide web 24. In one embodiment, the customer's computer 22 is loaded with a software application for communicating with the merchant's computer 20. The software application (e.g., a web-browser such as Microsoft's INTERNET EXPLORER, Mozilla's FIREFOX, or Google's CHROME) residing in the customer's computer 22 interacts with a website of the merchant residing at merchant's computer 20 to display a web graphical user interface (GUI)(e.g., a webpage) 22A on the customer's computer 22 allowing the customer to input various data relating to the merchandise purchased, personal information such as the customer's desired shipping address, and relevant customer's financial information such as customer's credit card data and the address of record associated with the credit card account. For example, the end customer can input the credit card data into the webpage 22A when placing a purchase order or subscribing to a recurring service.

As described above, when the input is completed, the credit card data is encrypted using Secure Socket Layer (SSL) or “https://” protocols and transmitted to the merchant's computer (e.g., web server computer) 20. As stated above, SSL creates a secure connection between the client computer 22 and the server computer 20. The data in transit is well protected using SSL protocol against anyone monitoring the data traffic on the public internet or world wide web, as the SSL protocol is highly secure. Therefore, the SSL protocol protects the data while being transmitted between the customer's computer 22 and the merchant's server computer 20. However, as discussed above, once the data reaches the merchant's server computer 20, the SSL encryption is removed, i.e., the data is decrypted, by the server computer 20 for saving in memory 20A of the server computer 20. This can render the data vulnerable to attack.

In order to remedy this deficiency, in one embodiment, the credit card data can be doubly encrypted. According to an embodiment of the present invention, there is provided a secure cryptographic processor 25. In one embodiment, the cryptographic processor 25 can be implemented as a cryptographic card. In the following paragraphs, it will be referred to the cryptographic processor as a cryptographic card. However, as it can be appreciated, this is merely one embodiment of the cryptographic processor as the cryptographic processor can be implemented, for example, as a computer subsystem (i.e., a cryptographic computer subsystem) that is configured to execute cryptographic operations or, for example, as a cryptographic coprocessor that can supplement the functions of a primary processor (i.e., CPU). Furthermore, it must be appreciated that a cryptographic processor as used herein can refer to one or more cryptographic processors. As depicted in FIG. 2, the cryptographic card 25 is outside server computer 20 but in communication with server computer 20. However, as it can be appreciated, the cryptographic card 25 can be installed in the server computer 20 and may thus be a part of the server computer 20. In one embodiment, the cryptographic card 25 is an IBM 4764-PCI coprocessor card manufactured by IBM corporation. In one embodiment, the cryptographic card 25 performs cryptographic operations in an impenetrable Federal Information Processing Standard (FIPS) FIP-140-level 2, 3 or 4 environment. As it can be appreciated, the FIPS standard can be implemented as a software application that can be run by one or more processors of the cryptographic card 25 or as hardware in an application specific integrated circuit (ASIC) of the cryptographic card 25.

In one embodiment, the cryptographic card 25 is a complete stand-alone computer having its own operating system which can be programmed to perform a variety of tasks which cannot be monitored or observed by parties even in close vicinity to the cryptographic card 25. In addition to custom programmed operations, the cryptographic card 25 can store modest amounts of key material (symmetric or asymmetric) in battery-backed random access memory (RAM). An example of utilization of this type of cryptographic card can be found in U.S. Pat. No. 6,005,945.

In one embodiment, a pair of “asymmetric” keys can be used to encrypt and decrypt data. The pair of keys include a public encryption key and a private encryption key. The pair of “asymmetric” keys can be created in a computational environment using a strong, large random number generator. In one embodiment, the public encryption key and the private encryption key can be generated substantially simultaneously by the cryptographic processor (e.g., cryptographic card) 25. However, as it can be appreciated, the public encryption key and the private encryption key can also be generated by the cryptographic processor 25 at different times (i.e., not simultaneously), for example, sequentially. The private key is an extremely large random prime number. The public key is computed using modular arithmetic as a function of the private key. The size of the two numbers (keys) are such that knowing the public key does not allow one to back-calculate the corresponding private key.

Typical key lengths are 1024 or 2048 bits (128 bytes or 256 bytes). Two protocols are commonly used which are RSA and Digital Signature Algorithm (DSA). Public/private key pairs can be used in encryption and/or authentication. In encryption, a small amount of data (less than the key length) is encrypted with the public key component. The data may then only be decrypted using the corresponding private key. Using the public key to imply the corresponding private key is “computationally infeasible.” In authentication, the private key can be used to “digitally sign” a data stream. The data itself is generally not encrypted, but it appears with an additional binary signature appended to the data (e.g. “Michelle Obama is the First Lady” might be the data to be signed). The corresponding public key can be used to confirm the authenticity of the data.

In the case of encryption, any other party having access to the public key and a computational engine, can encrypt any type of data and transmit that to the party holding the corresponding private key. Only the party holding the private key can decrypt these messages. While the public can be freely distributed, the private key must be carefully guarded by the originator of the key pair.

The public/private encryption (or asymmetric encryption) is used in many computer systems or web servers operating the SSL protocol. In SSL, a key pair can be generated using a web administrative software. The private key is typically stored is the web server's cryptographic registry. The public key is usually transmitted to an authentication authority such as VERISIGN. Using a variety of techniques, the authentication authority (e.g., VERISIGN) verifies the identity of an entity (e.g., a company) submitting the public key material. When the entity is verified, VERISIGN digitally signs the public key using a private signing key of the authentication authority (e.g., VERISIGN private signing key) and returns the signature in the form of an X509 certificate.

The X509 certificate of the entity (e.g., company) is transmitted to any client PC attempting to set up secure communications to the company's web server. The client PC will examine the X509 certificate and verify its authenticity using the public key of the authentication authority (e.g., VERISIGN public key). The VERISIGN public key (along with other authenticating authorities' keys) is loaded on a client personal computer (PC) when one installs any of the web browsers (such as Firefox, Internet Explorer, Safari, etc). Once the digital signature is verified by the client PC, the entity's public key is read from the received X509 certificate. The client PC then computes a random number that will be used for subsequent symmetric encryption. However, the web server of the company must also know this symmetric “session key.” To transmit this session key securely to the Web server, the client PC encrypts the session key by using the entity's public key. Only the entity (e.g., company) holding the corresponding private key can decrypt this temporary session key. Once the session key is known by both parties (the client and the entity or company), any amount of data may be securely transmitted between those parties. The reason that asymmetric encryption is not used for the entire session is that it is relatively computationally intensive compared to symmetric encryption/decryption.

In another embodiment, a secure key pair, such as, but not limited to, an RSA key pair or a Digital Signature Algorithm (DSA) key pair, is generated inside the cryptographic card 25 so that no one knows the private component of the key pair. In one embodiment, the public encryption key and the private encryption key can be generated substantially simultaneously by the cryptographic processor (e.g., cryptographic card) 25. However, as it can be appreciated, the public encryption key and the private encryption key can also be generated by the cryptographic processor 25 at different times (i.e., not simultaneously), for example, sequentially. The secure asymmetric RSA or DSA key pair is different from the SSL based symmetric encryption described in the above paragraphs. The public component of the secure key pair can be transmitted at any time based on an authenticated cryptographic command, for example as an X509 certificate. In one embodiment, the RSA public key is 1024 bit key. The complete RSA key can be security cloned to other cryptographic cards following a FIPS certified process. A secure cloning process may be needed in a system with heavy traffic where multiple load balanced server computers, such as server computer 20, each associated with one or more cryptographic cards, such as cryptographic card 25, are used.

A 1024 bit RSA public key can encrypt about 119 bytes of information. The remaining 9 bytes (128 bytes-119 bytes) is randomly generated with each encryption so that the encrypted value varies each time even if the message to be encrypted is the same. The 9 bytes is referred to as “nonce” in cryptography. All of the data in a credit card including a complete credit card number, expiration date, and CCV2 value is usually considerably less than 119 bytes. The RSA public key can be used to encrypt a sensitive portion of the data such as the credit card number, expiration date, and CCV2 and leave another portion of the data, a non-sensitive portion of the data, such as an account number of the user at the merchant server or an action code known to the merchant server not encrypted but the RSA public key.

The credit card data is first encrypted by the customer's computer (client computer) 22 using the RSA public key of the cryptographic card 25 associated with the merchant's computer 20. The data encrypted by the client computer 22 can only be decrypted by the RSA private key which is kept within cryptographic card 25 (e.g., an IBM 4764-PCI coprocessor card operating in a FIP-140-2/3/4 environment). The data encrypted by the client computer 22 is sent to the server computer 20. The server computer 20 receives the encrypted data sent by the client computer 22 and transmits the encrypted data to the cryptographic card 25. The cryptographic card 25 receives the encrypted data from the server computer 20. Hence, the data is completely encrypted when it reaches the server computer 20 and thus of not use to an inside monitor or “bot.”

In addition to encrypting the data using the RSA protocol, the data can be optionally further encrypted using the standard SSL protocol. The SSL encryption is a redundant level of encryption and not necessary. The SSL encryption can be added as a supplement to satisfy those who don't fully understand the RSA private key encryption process and “insist” on SSL or https as an indicator of security. In addition, the SSL encryption may also serve to encrypt the non-sensitive portion of the data not encrypted by RSA encryption.

It is worth noting that the SSL protocol may also employ an RSA public key to exchange the symmetric session key. However, the website based public SSL key is separate and distinct from the cryptographic card 25 public key.

A conventional web browser, installed in the client computer 22 that displays the web graphical interface 22A, may not have the computational ability to handle the first-stage RSA encryption process (i.e., the RSA encryption by the cryptographic card 25). However, in one embodiment, the RSA encryption can be accomplished by using a Java applet or a .NET plug-in in the web browser if a browser is preferred for the customer experience. Alternatively, instead of a web browser, a client software application can be installed on the customer's computer 22 and used to communicate with the merchant's server 20.

The first level RSA encryption is unaffected by the SSL encryption/decryption processes. When the merchant's server computer 20 uses SSL to decrypt the encrypted data received from customer's computer 22, the memory 20A in the server computer 20 sees the first level of RSA encryption. In other words, the data remains encrypted with the RSA encryption. The only portion of data that is in the clear is the portion of the data that was not encrypted by the RSA public key (i.e., for example the portion of the data such as the account number of the user at the merchant server, an action code, etc. that was only encrypted with the SSL public key). Thus, the memory 20A does not store the RSA encrypted data as “clear text.” The RSA encrypted data is stored in the memory 20A and the RSA encrypted data is passed back from the memory 20A into the cryptographic card 25 (e.g., through a PCI bus). In one embodiment, the portion of the data (e.g., an account number of the user at the merchant, an action code, etc.) that is not encrypted with the RSA public key and is decrypted with the SSL key can be used to link or associate the RSA encrypted data with the appropriate user account, etc. Once inside the cryptographic card 25, the credit card data can be decrypted. Since the encrypted data is decrypted inside the cryptographic card 25, the decrypted data is free from “insider monitoring” or “bot” threats as the cryptographic card 25 is highly secure. The decrypted data can be stored in an internal memory of the cryptographic card 25.

The decrypted credit card data which is safely stored in the cryptographic card 25 can be re-encrypted with a symmetric encryption key and sent for long term storage to the storage database 26. Alternatively, the decrypted data can be immediately encrypted with the public encryption key provided or distributed by payment gateway computer 28 (e.g., FDMS) for sending to payment gateway computer 18 for payment processing. The encryption public key distributed by the payment gateway computer 28 can be for example an RSA encryption key or an SSL encryption key.

When the credit card data is sent for either long term storage in database 26 or transmitted to the payment gateway computer 28 via the internet 24 or dedicated transmission line 27, the data is once again encrypted when present in the memory 20A (for example, using the SSL encryption protocol).

Credit card data encrypted with the cryptographic card 25 public key can only be decrypted by the private key component of cryptographic card 25. If, for example, the merchant chooses to store the credit card data in the database 26, the data stored in the database 26 can be encrypted with either the RSA public encryption key associated with the merchant's cryptographic card 25, or the data encrypted with a symmetric master key which is also stored inside the cryptographic card 25. Encrypted data using a symmetric master key may be faster to decrypt than encrypted data with for example an RSA key allowing faster retrieval of the encrypted data at a later time if desired.

From the above, it can be seen that the credit card data can be protected at all times using two asymmetric (public and private) key pairs. One key pair (public key and private key) is created and maintained by the merchant's server computer and one key pair (public key and private key) created and maintained by the payment gateway computer 28. The payment gateway computer 28 can distribute their public key freely to thousands of merchants' computers 20. The merchants computers 20 would in turn distribute their public keys to the computers 22 of the merchant's clients. This can be accomplished, for example, via Java applets transmitted through the world wide web 24 or via a dedicated software application installed on the customer's computer 22.

Although the system and method of providing secure transmission is discussed in the above paragraphs with relation to financial credit card data, as it can be appreciated the above system and method can be used in various other applications. For example the system and method described in the above paragraphs can be used to protect any type of sensitive information, not just financial information such as credit card information. The sensitive information that may need protection include medical information, vital records, and other sensitive information that must be held by an intermediate party (without the intermediate party having access to the information). For instance, the social security information (e.g., social security number) held by a tax preparer could be stored on or manipulated by the tax preparer's computer system and electronically transmitted to the U.S. internal revenue service (IRS) without the tax preparer ever “seeing” this information “in the clear,” as the information is maintained encrypted using an RSA encryption key generated by a cryptographic card associated with the tax preparer computer system. For instance, the social security information transmitted to the IRS would be encrypted with the IRS public key inside the tax preparer's cryptographic processor. The social security number of the client of the tax preparer can be transmitted to the tax preparer's computer using a Java-enabled browser or other client software application installed on the client's computer.

In the above paragraphs, the system and method are described as utilizing an RSA encryption/decryption protocol. However, as it can be appreciated, other asymmetric encryption/decryption protocols can also be used such as a DSA protocol.

It is recognized that implementation of this security measure may require the cooperation of the existing credit card processors or the introduction of new, highly secure “feeder” entities which would meet the extraordinarily high security standards required for this mission. But in any case, the number of top-tier processors who would need to offer public key encryption options will likely number in the 10-20 range. These entities will in turn service 100's of thousands of merchants.

As described in the above paragraphs, the method and system are more particularly described for securing data between the customer's computer and the merchants' computer. However, as it can be appreciated the method and system described herein can also be employed by the payment gateway computer and/or authorizing agent computer 28 for communication with the merchant's computer 20 or with a financial institution's computer 29 (e.g., bank holding the customer's credit card account) to secure data between the payment gateway computer 28 and the merchant's computer 20 and/or between the payment gateway computer 28 and the financial institution's computer 29.

As it can be appreciated, the above described method and system enables merchants' computers to gather, store, and process credit card information without ever exposing the credit card information in the memory of the computers.

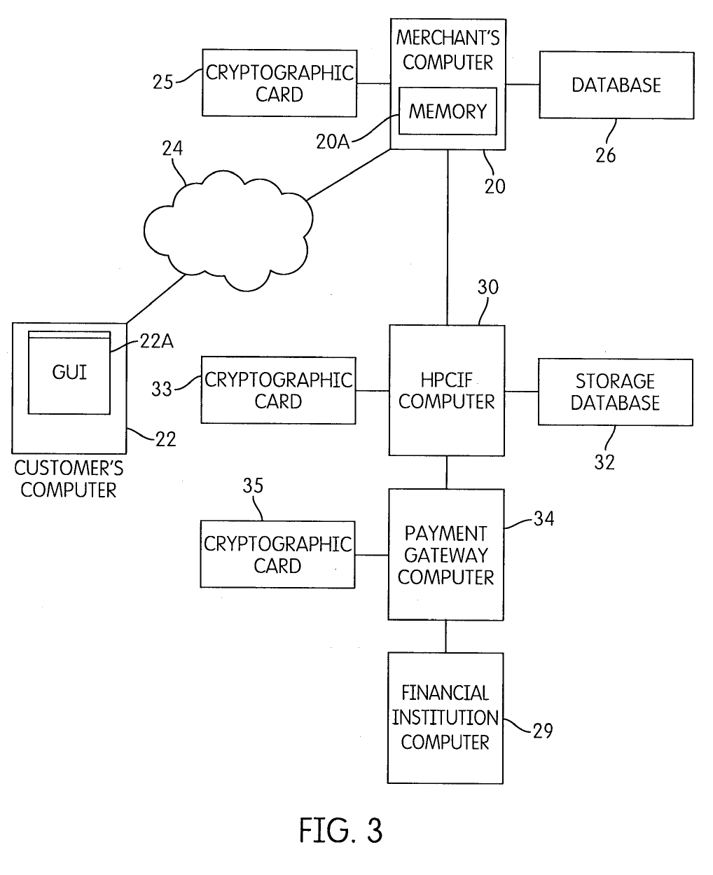

In yet another embodiment of the present invention, instead of merchant's computer 20 processing and/or storing the sensitive credit card data, a computer 30 associated with another entity can be dedicated for that purpose. FIG. 3 depicts the computer 30 for processing and/or storing the sensitive credit card data in communication with the merchant's computer 20. Although, the computer 30 is depicted in FIG. 3 as communicating with the merchant's through a direct link, as it can be appreciated, the computer 30 and the merchant's computer 20 can also communicate via the internet or worldwide web 24. The computer system depicted in FIG. 3 is similar in many aspects to the computer system depicted in FIG. 2. Therefore, similar reference characters would be used to indicate similar elements or components.

In the system depicted in FIG. 3, instead of a plurality of merchants' computers 20 processing and/or storing the sensitive credit card data, this operation can be performed by a relatively small number of computers 30 associated with entities distinct from the merchant. These entities are referred to herein as highly-PCI-compliant firms (HPCIFs). In one embodiment, these entities would do nothing but store and process the sensitive credit card data. The HPCIFs computers 30 would communicate with the merchants computers 20 to process credit card transactions for the plurality of merchants and store the credit card data in storage database 32 under the control of the HPCIF computer 30. Hence, each merchant's computer 20 will no longer store the credit card data received from the plurality of computers 22 associated with the customers of the merchant. The sensitive data would be collected in a highly secure manner and transmitted to the HPCIF computer 30 using the public key encryption protocol described previously.

In one embodiment, a merchant can, for example, subscribe with the HPCIF to outsource the credit card processing and card data storage service to the HPCIF entity. In one embodiment, the merchant (e.g., e-merchant) can provide the HPCIF with its credit card merchant ID and password. In this way, the HPCIF computer 30 can act as a proxy for the merchant computer 20 in the credit card authorization process.

In one embodiment, when collecting new or updated credit card data, the merchant computer 20 can assign a unique identification (“credit card ID”) to the credit card that is used by the customer to make a purchase or transaction. The merchant's computer 20 then stores the unique credit card ID associated with the credit card (i.e., credit card data) in its customer database 26. The credit card ID is also forwarded to the HPCIF computer 30 along with the actual credit card data. In one embodiment, the merchant's computer 20 securely transmits the following customer and credit card data to the HPCIF computer 30.

### 1. Merchant ID for the HPCIF

2. Merchant's password for the HPCIF account
3. Credit card ID assigned by the merchant to the credit card
4. Customer's credit card number (encrypted with IICPIF's public key)
5. Expiration date of the customer's credit card
6. CCV2 of the customer's credit card
7. Billing ZIP code of the customer
8. Billing street address of the customer

The HPCIF computer 30 then stores the encrypted credit card data in the storage database 32 in an encrypted state under a PCI-compliant environment for future use. By “future use” it is meant either seconds after initially transmitting the encrypted card data or on a recurring basis (e.g., daily, weekly or monthly basis) in subscription scenarios.

When the merchant initiates a credit card authorization process, the merchant's computer 20 computes a value of the credit card transaction (e.g., the amount of purchase) and retrieves the credit card ID (associated with the credit card of the customer) from the database 26. Note that neither the merchant's computer 20 nor the database 26 associated with the merchant's computer 20 have any of the actual credit card data but simply a credit card ID number pointing to an encrypted data record of the credit card number stored in the storage database 32 associated with the HPCIF computer 30.

For example, the merchant's computer 20 compiles the following data during the authorization and sends a request to the HPCIF computer 30.

### 1. Merchant ID for the HPCIF

2. Merchant's password for the HPCIF account
3. Credit card ID assigned by the merchant the credit card
4. Transaction amount

When the HPCIF computer 30 receives the request from the merchant's computer 20, the HPCIF computer 30 reads the encrypted credit card data stored in the secure storage database 32. The HPCIF computer, then temporally decrypts the encrypted credit card data stored in the storage database 32 and assembles a complete authorization transaction request (which includes the actual credit card data). The HPCIF computer 30 then transmits the complete authorization transaction request to the payment gateway computer or credit card processor computer (e.g. FMDS) 34. The authorization request includes the merchant's ID and the merchant's password as the funds are destined for the merchant's account. The payment gateway computer 34 would send a message to the HPCIF computer 30 authorizing or declining the HPCIF authorization request. The message would in turn be passed back by the HPCIF computer 30 to the merchant's computer 20.

Therefore, the merchant computer 20 can perform authorizations on the customer's credit card without actually storing the credit card sensitive data. This allows the merchant to eliminate the need to adopt the expensive and stifling PCI protocols within the merchant's organization. The merchant computer 20 can receive a response for an authorization request in a same time as if the merchant computer 20 directly communicates with the payment gateway computer 34. The authorization request in this instance is devoid of any specific credit card data and uses instead a unique credit card ID number.

In one embodiment, the HPCIF entity can impose a small charge during the transaction for the services it provides (i.e., processing and storing of the secure credit card data). For instance, the HPCIF entity can charge 5 cents ($0.05), for example, per credit card authorization or, for example, 1% of the transaction amount. The merchant is already conditioned to pay up to 20 cents per transaction as well as 2% to 4% of the transaction amount. Therefore, the additional small amount of $0.05 or 1% of the transaction amount may be acceptable. For the additional small amount, the merchant can be completely free from the burdens of PCI compliance.

In the above paragraphs, the HPCIF computer 30 is described as communicating data with the payment gateway computer or authorization processor (e.g. FDMS) 34 using simple SSL encryption. However, if payment gateway computer 34 also adopted a public/private key security protocol, the credit card data could be completely encrypted at all times, from the input of the credit card data into the customer's computer 22 to the financial institution computer 29 providing an authorization response.

There are a number of public/private key encryption scenarios that can be employed for the overall data flow. One scenario would be that the merchant computer 20 generates a first key pair to securely transmit the encrypted data from the customer's computer 22 to the cryptographic card 25 associated with the merchant's computer 20 (as described in the above paragraphs). In one embodiment, the public encryption key and the private encryption key can be generated substantially simultaneously by the cryptographic processor (e.g., cryptographic card) 25. The HPCIF computer 30 then generates a second key pair to move data from the cryptographic card 25 associated with the merchant's computer 20 to a cryptographic card 33 associated with the HPCIF computer 30. In one embodiment, the public encryption key and the private encryption key can be generated substantially simultaneously by the cryptographic processor (e.g., cryptographic card) 33. However, as it can be appreciated, the public encryption key and the private encryption key can also be generated by the cryptographic processor 33 at different times (i.e., not simultaneously), for example, sequentially. Optionally, the payment gateway computer or payment processor 34 can then generate a third key pair to further move the data from the cryptographic card 33 associated with the HPCIF computer 30 to a cryptographic card 35 associated with the payment gateway computer 34. In one embodiment, the public encryption key and the private encryption key can be generated substantially simultaneously by the cryptographic processor (e.g., cryptographic card) 35. However, as it can be appreciated, the public encryption key and the private encryption key can also be generated by the cryptographic processor 35 at different times (i.e., not simultaneously), for example, sequentially.

In another scenario, the key pair generated by the merchant's computer 20 can be eliminated and thus the cryptographic card 25 may not be needed. In which case, the public key of the HPCIF computer 30 would be distributed to all the computers 22. The credit card data would then be completely encrypted when received by the merchant's computer 20.

In one embodiment, the role of the HPCIF computer 30 can be supplanted by employing enhanced cryptographic measures at the payment gateway computer 34. Indeed, if the payment gateway computer 34 adopts asymmetric key encryption protocols, the HPCIF computer 30 can be eliminated.

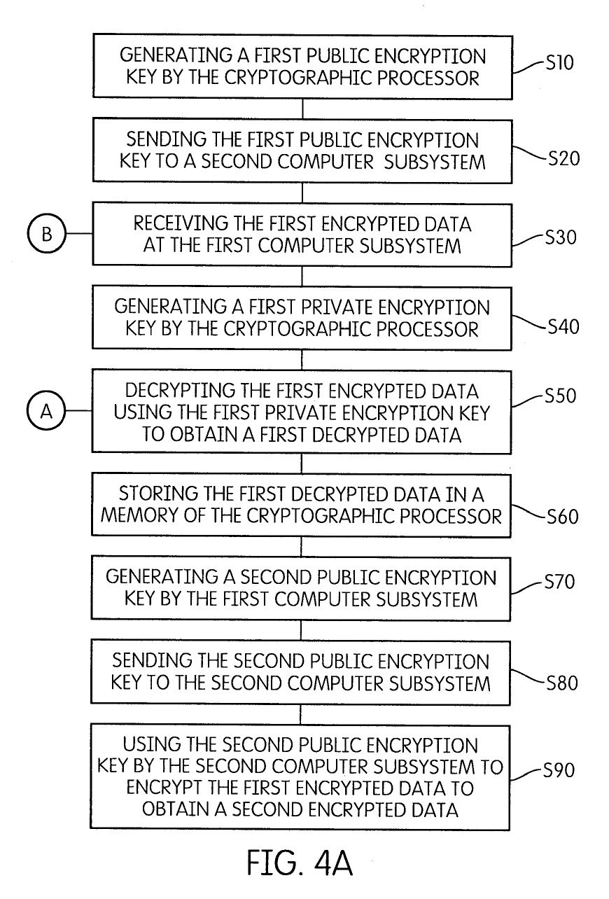

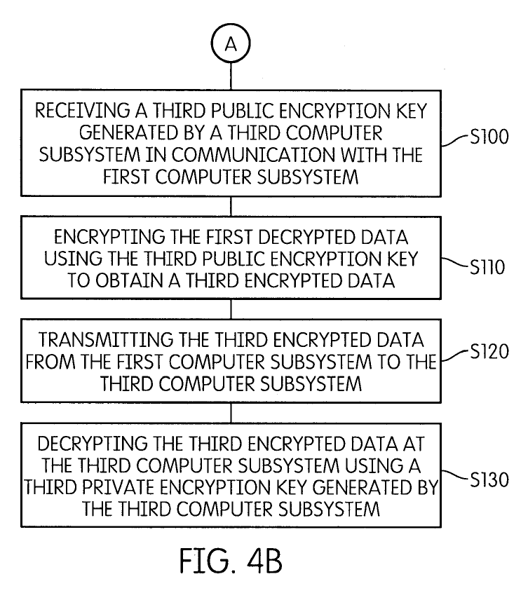

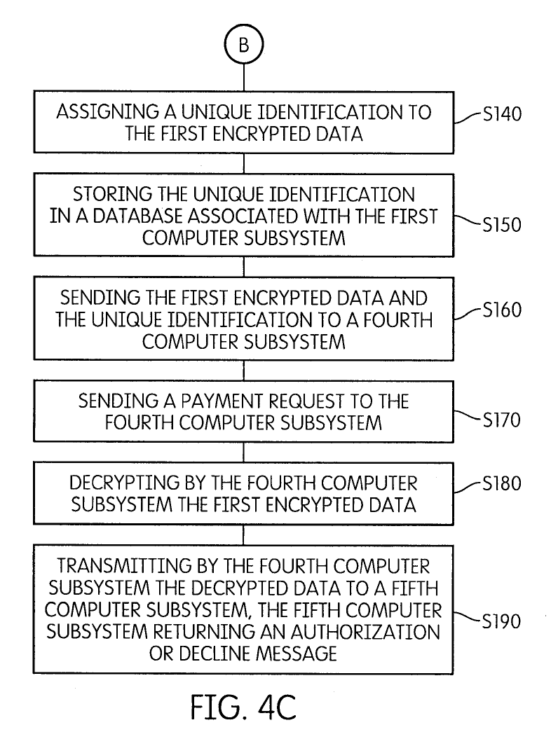

Therefore, as it can be appreciated from the above paragraphs, a method for securing data is provided. FIGS. 4A, 4B and 4C depict a flow chart of the method for securing data, according to an embodiment of the present invention. As shown in FIG. 4A, The method includes generating a first public encryption key by the cryptographic processor (e.g., cryptographic card) 25 associated with a first computer subsystem (e.g., merchant's computer) 20, at S10. The first public encryption key can be a RSA public encryption key or a DSA public encryption key.

The method further includes sending the first public encryption key to a second computer subsystem (e.g., customer's computer) 22, at S20. The second computer subsystem 22 uses the first public encryption key to encrypt first data (e.g., credit card data). The method further includes receiving the first encrypted data at the first computer subsystem 20, at S30. The method also includes generating a first private encryption key by the cryptographic processor 25, at S40, decrypting the first encrypted data using the first private encryption key generated by the cryptographic processor 25 to obtain a first decrypted data, at S50, and storing the first decrypted data in a memory of the cryptographic processor, at S60.

In one embodiment, the first decrypted data can be re-encrypted and the re-encrypted data stored in the storage database 26 associated with the first computer subsystem 20.

In one embodiment, the method further includes generating a second public encryption key (for example, a SSL public encryption key) by the first computer subsystem 20, at S70, and sending the second public encryption key (e.g., the SSL public encryption key) to the second computer subsystem 22, at S80. The second computer subsystem 22 uses the second public encryption key (e.g., the SSL public encryption key) to encrypt the first encrypted data to obtain a second encrypted data, at S90.

As shown in FIG. 4B, starting at point A in FIG. 4A, in one embodiment, the method further includes receiving a third public encryption key generated by a third computer subsystem (e.g., payment gateway computer 28) in communication with the first computer subsystem (e.g., merchant's computer) 20, at S100, and encrypting the first decrypted data (which is decrypted using the first private encryption key generated by the cryptographic processor 25) using the third public encryption key to obtain a third encrypted data, at S110.

In one embodiment, the method further includes transmitting the third encrypted data from the first computer subsystem 20 to the third computer subsystem (e.g., payment gateway computer) 28, at S120, and decrypting the third encrypted data at the third computer subsystem 28 using a third private encryption key generated by the third computer subsystem 28 to obtain a third decrypted data, at S130.

As shown in FIG. 4C, starting at point B in FIG. 4A, in one embodiment, the method further includes assigning a unique identification to the first encrypted data, at S140; storing the unique identification in a database associated with the first computer subsystem 20, at S150; and sending the first encrypted data and the unique identification to a fourth computer subsystem (e.g., HPCIF computer) 30, at S160. In one embodiment, the fourth computer subsystem 30 stores the first encrypted data and the unique identification in a storage database 32 associated with the fourth computer subsystem 30.

In one embodiment, the method further includes sending a payment request to the fourth computer subsystem 30, at S170. The payment request includes the unique identification number and a transaction amount. In one embodiment, the fourth computer subsystem 30 reads the first encrypted data associated with the unique identification. Decrypting by the fourth computer the first encrypted data stored in the storage database 32 associated with the fourth computer subsystem 30 to obtain decrypted data at the fourth computer subsystem 30, at S180. The fourth computer subsystem 30 transmits the decrypted data to a fifth computer subsystem (e.g., payment gateway computer) 34, the fifth computer subsystem 34 returning an authorization or decline message, at S190.

Although the various steps of the method are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

1. A method for securing data, comprising:
generating a first public encryption key by a cryptographic processor associated with a first computer subsystem;
sending the first public encryption key to a second computer subsystem;
receiving first encrypted data at the first computer subsystem, the first encrypted data having been encrypted by the second computer subsystem using the first public encryption key;
generating a first private encryption key by the cryptographic processor;
decrypting the first encrypted data using the first private encryption key generated by the cryptographic processor to obtain first decrypted data; and
storing the first decrypted data in a memory associated with the cryptographic processor.

2. The method according to claim 1, wherein generating the first public encryption key and generating the first private encryption key by the cryptographic processor are performed substantially simultaneously.

3. The method according to claim 1, further comprising providing a memory in the first computer subsystem and storing the first encrypted data in the memory of the first computer subsystem.

4. The method according to claim 1, wherein the first computer subsystem is a computer subsystem of a merchant and the second computer subsystem is a computer subsystem of a customer of the merchant.

5. The method according to claim 1, wherein generating the first public key by the cryptographic processor comprises generating a RSA public encryption key or generating a DSA public encryption key by the cryptographic processor.

6-23. (canceled)

24. A computer system for securing data, comprising:
a cryptographic processor configured to generate a first public encryption key and a first private encryption key; and
a first computer subsystem in communication with the cryptographic processor, the computer subsystem being configured to:
receive first encrypted data having been encrypted using the first public encryption key generated by the cryptographic processor; and
transmit the first encrypted data to the cryptographic processor,
wherein the cryptographic processor is configured to decrypt the first encrypted data using the first private encryption key to obtain a first decrypted data.

25. The computer system according to claim 24, wherein the cryptographic processor is configured to generate the first public encryption key and the first private encryption key substantially simultaneously.

26. The computer system according to claim 24, wherein the cryptographic processor comprises a memory configured to store the first decrypted data.

27. The computer system according to claim 24, wherein the first computer subsystem comprises a memory configured to store the received first encrypted data.

28. The computer system according to claim 24, wherein the cryptographic processor is configured to generate a RSA public encryption key or generate a DSA public encryption key.

29. The computer system according to claim 24, wherein the first computer subsystem is configured to communicate with a second computer subsystem, wherein the first encrypted data is encrypted by the second computer subsystem using the first public encryption key.

30-32. (canceled)

33. The computer system according to claim 24, further comprises a storage database in communication with the first computer subsystem, wherein the cryptographic processor is configured to further re-encrypt the first decrypted data and store the re-encrypted data in the storage database.

34. The computer system according to claim 24, wherein the first computer subsystem is configured to:
receive a third public encryption key generated by a third computer subsystem in communication with the first computer subsystem; and encrypt the first decrypted data using the third public encryption key to obtain a third encrypted data.

35-40. (canceled)

41. The computer system according to claim 24, wherein the first computer subsystem is configured to:
assign a unique identification to the first encrypted data;
store the unique identification in a database associated with the first computer subsystem; and
send the first encrypted data and the unique identification to a fourth computer subsystem.

42. The computer system according to claim 41, wherein the fourth computer subsystem stores the first encrypted data and the unique identification in a storage database associated with the fourth computer subsystem.

43. The computer system according to claim 42, wherein the first computer is further configured to send a payment request to the fourth computer subsystem, the payment request including the unique identification number and a transaction amount.

44. The computer system according to claim 43, wherein the fourth computer subsystem is configured to read the first encrypted data associated with the unique identification and decrypts the first encrypted data stored in the storage database associated with the fourth computer subsystem to obtain decrypted data at the fourth computer subsystem.

45. The computer system according to claim 44, wherein the fourth computer subsystem is configured to transmit the decrypted data to a fifth computer subsystem, the fifth computer subsystem returning an authorization or decline message.

46. The computer system according to claim 45, wherein the fifth computer subsystem is a payment gateway computer.

47. The method according to claim 45, wherein the first computer subsystem is configured to receive the authorization or decline message.
